(19) United States
(12) Patent Application Publication
(10) Pub. No.: US 2017/0080757 A1
(43) Pub. Date: Mar. 23, 2017

(54) A PNEUMATIC RADIAL TIRE WITH HYBRID CORD REINFORCEMENT

(71) Applicant: KORDSA GLOBAL ENDUSTRIYEL IPLIK VE KORD BEZI SANAYI VE TICARET ANONIM SIRKETI, Ízmit (TR)

(72) Inventors: Kürsat AKSOY, Ízmit (TR); Bekir Anll MERTOL, Ízmit (TR); Ahmet Burak ILGUN, Ízmit (TR); Sadettin FIDAN, Garbsen (DE)

(73) Assignee: KORDSA GLOBAL ENDUSTRIYEL IPLIK VE KORD BEZI SANAY I VE TICARET ANONIM SIRKETI, Ízmit (TR)

(21) Appl. No.: 15/123,647

(22) PCT Filed: Mar. 10, 2015
(86) PCT No.: PCT/TR2015/000104

§ 371 Date: Sep. 5, 2016

(30) Foreign Application Priority Data
Mar. 12, 2014 (TR) 2014/02944

(51) Int. Cl. B60C 9/00; D02G 3/48; B60C 9/20

(52) U.S. Cl. CPC B60C 9/005; B60C 9/2003; D02G 3/48; B60C 2009/208; B60C 2009/2093; B60C 2009/2257

(57) ABSTRACT

Pneumatic radial tire comprising a tread (4) forming the outermost layer of the tire (1) and at least one belt (5) on top of the carcass (3) forming the “inner layer” of the tire (1). As cap ply reinforcement layer (6) hybrid cords are applied comprising polyethylene terephthalate (PET) and nylon 6.6 multifilament yarns to provide a pneumatic radial tire having high speed durability and a low flatspot feature.

### FIELD OF THE INVENTION

The present invention relates to the application of hybrid cords comprising polyethylene terephthalate (PET) and nylon 6.6 multifilament yarns as cap ply reinforcement material in pneumatic radial tires which have high speed durability and low flatspot feature.

### BACKGROUND OF THE INVENTION

It is known that reinforcement materials that are wound spirally with a small angle with the equatorial plane on the belt package especially improve the high speed performance in radial tires. Using polymeric (nylon 6.6, PET, aramide/nylon etc.) cords as cap ply reinforcement as strips has been applied for many years by several tire companies in order to improve high speed durability and handling performance in pneumatic radial tires. The said cord strips are obtained by cutting calendered (rubberized) cord fabric in strips or rubberizing parallel single cords in a certain width during extrusion process.

The purpose of using the cap ply reinforcement is to increase the high speed durability of the tire by avoiding belt layer separation caused by the centrifugal force occurring in the belt package at high speeds. Especially the intensity of the resistance shown by the tire against belt edge separations is highly important for high speed durability.

When the nylon is used as cap ply reinforcement material, there are two important disadvantages. First one is the obligation to be used as more than one layer due to its low modulus. And the second one is the temporary geometric deformation (flatspot) caused as a result of cooling the tire heated at high speed upon parking, since the glass transition temperature (Tg) of the polymer is low.

U.S. Pat. No. 7,584,774, an application known in the state of the art, discloses the use of high modulus polyethylene terephthalate cord as cap ply reinforcement material in order to increase the high speed durability of tire and decrease the temporary geometric deformation (flatspot) problem. In this embodiment wherein the tangent modulus of the cap ply cord is suggested being higher than 2.5 mN/dtex. % at 160° C. under 29.4N, there is a risk of the cords cutting the coating rubber during vulcanization process. For this reason it is suggested that the process expansion will be maximum 2%. Furthermore, the fatigue failure risk of polyethylene terephthalate cord, which has higher modulus than nylon 6.6 cord, under cyclic deformation is higher than nylon 6.6 cord.

German Patent documents no DE10201210.5766 and DE102007025490 known in the state of the art, disclose a strength support layer for elastomeric products and a pneumatic vehicle tyre which contains at least one strength support layer.

In order to increase the high speed durability of the tire, the cap ply reinforcement cords located on the belt package should resist the tire growth that can occur from the centrifugal force at high speed.

The said tire growth resistance formed in the cap ply reinforcement cords is comprised the total of
stress (cold residual tension) occurring in the cap ply reinforcement cords after vulcanization process,
thermal shrink force generated due to increasing temperature of belt zone because of high speed,
and the cord modulus at the said temperature.

### SUMMARY OF THE INVENTION

The objective of the present invention is to provide a pneumatic radial tire comprising cap ply reinforcement.

Another objective of the present invention is to provide a pneumatic radial tire wherein the hybrid cords in cap ply reinforcement layer are comprised of polyethylene terephthalate (PET) and nylon 6.6 multifilament yarns.

A further objective of the present invention is to provide a radial tire reinforced with hybrid cord wherein the pressure on the belt cord is increased at high speed and temperature by increasing the thermal shrinkage force.

### BRIEF DESCRIPTION OF THE DRAWINGS

Pneumatic radial tire reinforced with hybrid cord developed to fulfill the objectives of the present invention is illustrated in the accompanying figures, in which:

FIG. 1 is the front sectional view of the inventive radial tire.

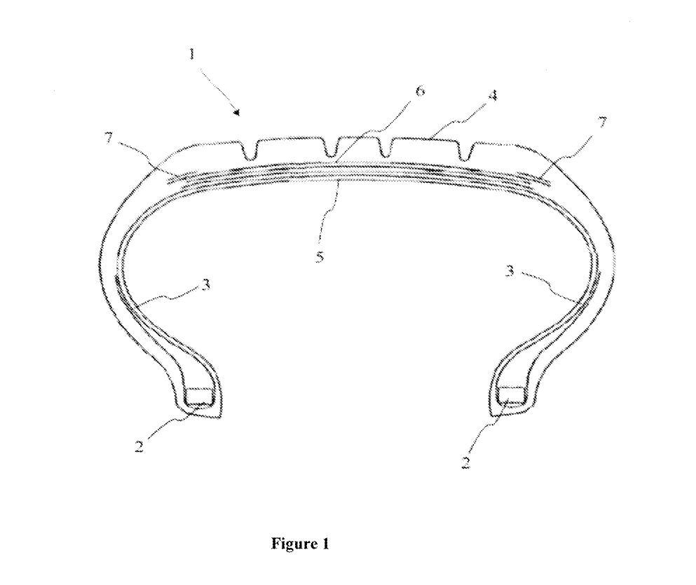

FIG. 2 is the perspective view of hybrid cord used as cap ply reinforcement layer

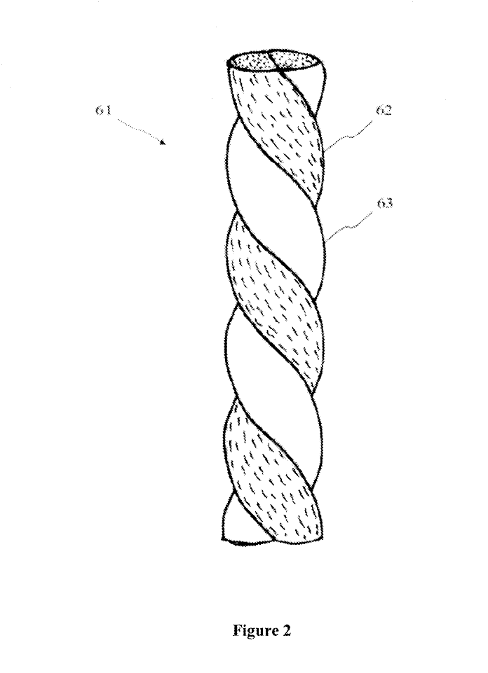

FIG. 3 is the definitions of Z and S twist directions of hybrid cords present in the cap ply reinforcement layer.

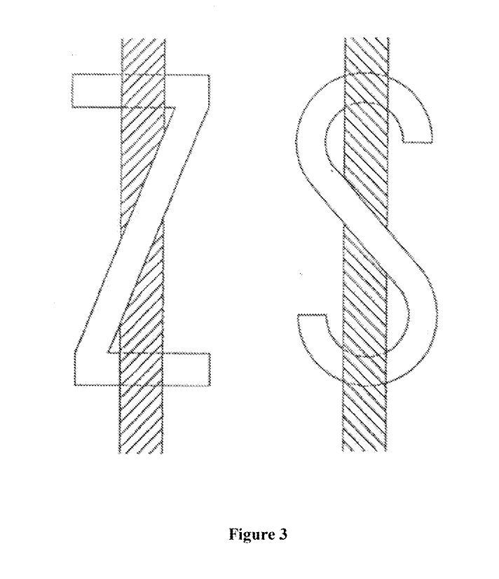

The components shown in the figures are each given reference numbers as follows:
1. A pneumatic radial tire reinforced with hybrid cord
2. Tire bead ring
3. Carcass
4. Tread
5. Belt
6. Cap ply reinforcement layer
61. Hybrid cord
62. PET multifilament yarn
63. Nylon 6.6 multifilament yarn
7. Belt edge reinforcement layer

### DETAILED DESCRIPTION OF THE EMBODIMENTS

The inventive pneumatic radial tire (1) essentially comprises at least one tread (4) forming the outermost layer of the tire (1) and at least one belt (5) on the carcass (3) forming the inner layer of the tire (1). The tire (1) is reinforced with at least one cap ply reinforcement layer (6) which is obtained by using hybrid cords (61) which are formed by twisting polyethylene terephthalate (PET) (62) and nylon 6.6 multifilament yarns (63) and the thermal shrinkage force and modulus of which are increased by applying heat-set process; therefore the high speed durability of the tire (1) is increased. The cap ply reinforcement layer (6) is between the tread (4) forming the outer layer of the tire (1) and the belt (5) formed of steel material. The cap ply reinforcement layer (6) is wound spirally on the belt (5) as strip such that it will for an angle between 0 and 5 degrees with the equatorial plane.

The heat-set process, which is a thermal process, comprises stretching hybrid cord (61) minimum 1% at 180-240° C. This process increases the tension value of the cord (61) corresponding to 3% level to minimum 8 mN/dtex at 25° C., and it increases the thermal shrinkage force above 2 mN/dtex at 177° C.

In heat-set process, the hybrid cords (61) are also provided with adhesive property with the rubber in the tire (1) by applying resorcinol formaldehyde latex (RFL) dip solution.

In the preferred embodiment of the invention, there is at least one belt edge reinforcement layer (7) wound on each side of the cap ply reinforcement layer (6) in order to support the cap ply reinforcement layer (6). Cap ply reinforcement layer (6) having hybrid cords (61) with increased thermal shrinkage force and wound on the belt (6) and the belt edge reinforcement layer (7) enable to increase high speed durability by providing resistance against the increase in diameter of the tire (1).

The hybrid cords (61) forming the cap ply reinforcement layer (6) are obtained by twisting pre-twisted PET (62) and nylon (63) yarns in Z or S direction such that they will be in reverse direction of the pre-twisting direction. The twisting level varies between 100 and 800 twists/meter, preferably 200 to 400 twists/meter. In the preferred embodiment of the invention, the twisting level of the hybrid cords (61) is equal to pre-twisting level of yarn or it has maximum 10% difference.

The width of the cap ply reinforcement layer (6) should be equal to the width of the belt (5) or it should be wider than the belt.

The width of the cap ply reinforcement layer (6) as strip which is used as wound around the belt (5) varies between 5 mm and 30 mm, preferably 8 mm to 15 mm. The number of cords (61) provided in 10 mm width of the cap ply reinforcement layer (6) can vary between 5 and 20.

The reinforcement layer (6) can exist in the tire (1) as coated with rubber or not coated with rubber. The linear densities* of the hybrid cords (61) in the cap ply reinforcement layer (6) are between 500 and 6000 dtex. In the preferred embodiment of the invention, the linear density of nylon 6.6 multifilament yarns (63) is smaller than the linear density of the PET multifilament yarns (62). In one embodiment of the invention, the linear density of nylon 6.6 yarns (63) forming the hybrid cord (61) is 1400 dtex, while the linear density of the PET yarns (62) is 1440 dtex. *The linear density is the weight of 10000 meters length of a yarn in unit of gram, and its unit value is dtex.

1. A pneumatic tire with hybrid cord reinforcement comprising:
a tread forming the outermost layer of the tire,
at least one belt on the carcass forming the inner layer of the tire, and
at least one cap ply reinforcement layer,
which is formed by twisting pre-twisted polyethylene terephthalate (PET) multifilament yarns and nylon yarns in Z or S direction such that they will be in reverse direction of the pre-twisting direction,
wherein the twisting level of the hybrid cords is equal to pre-twisting level of yarn or it has maximum 10% difference,
which is wound spirally (as strip) such that it will make an angle of 0 to 5° with the equatorial plane on the belt,
and wherein the cap ply reinforcement layer
the thermal shrinkage force and modulus of which are increased by stretching minimum 1% at 180-240° C.,
which is obtained by using hybrid cords the tensile force (LASE value) of which is minimum 8 mN/dtex at 3% elongation at 25° C. according to ASTM D855 test method, and the thermal shrinkage force of which is minimum 2 mN/dtex at 177° C. according to ASTM D855 test method.

2. The pneumatic radial tire with hybrid cord reinforcement according to claim 1, wherein at least one belt edge reinforcement layer which is provided on both sides of the cap ply reinforcement layer, and which enables to increase high speed durability by providing resistance against the increase in tire diameter.

3. The pneumatic radial tire with hybrid cord reinforcement according to claim 1, wherein at least one cap ply reinforcement layer which has hybrid cords that are formed by twisting polyethylene terephthalate (PET) multifilament yarns and nylon 6.6 multifilament yarns in Z or S direction in range of 100 to 800 twists/meter.

4. The pneumatic radial tire with hybrid cord reinforcement according to claim 3, wherein at least one cap ply reinforcement layer which has hybrid cords that are formed by twisting polyethylene terephthalate (PET) multifilament yarns and nylon 6.6 multifilament yarns preferably in twisting level of 200 to 400 twists/meter.

5. The pneumatic radial tire with hybrid cord reinforcement according to claim 1, wherein at least one cap ply reinforcement layer the width of which is equal to the width of the belt or wider than the width of the belt.

6. The pneumatic radial tire with hybrid cord reinforcement according to claim 5, wherein at least one cap ply reinforcement layer the strip width value of which is between 5 mm and 30 mm.

7. The pneumatic radial tire with hybrid cord reinforcement according to claim 6, wherein at least one cap ply reinforcement layer the strip width value of which is preferably between 8 mm and 15 mm.

8. The pneumatic radial tire with hybrid cord reinforcement according to claim 5, wherein at least one cap ply reinforcement layer wherein the number of hybrid cords in width of 10 mm varies between 5 and 20.

9. The pneumatic radial tire with hybrid cord reinforcement according to claim 5, wherein at least one cap ply reinforcement layer which has hybrid cords the linear densities of which are between 500 and 6000 dtex.

10. The pneumatic radial tire with hybrid cord reinforcement according to claim 9, wherein at least one cap ply reinforcement layer which has hybrid cords wherein the linear density of nylon 6.6 multifilament yarns is smaller than the linear density of the PET multifilament yarns.
